(19) United States
(12) Patent Application Publication
(10) Pub. No.: US 2012/0057671 A1
(43) Pub. Date: Mar. 8, 2012

(54) DATA ACQUISITION AND VISUALIZATION MODE FOR LOW DOSE INTERVENTION GUIDANCE IN COMPUTED TOMOGRAPHY

(75) Inventors: Michael Grass, Buchholz In Der Nordheide (DE); Eberhard Sabastian Hansis, Menlo Park, CA (US)

(73) Assignee: KONINKLIJKE PHILIPS ELECTRONICS N.V., EINDHOVEN (NL)

(21) Appl. No.: 13/320,941

(22) PCT Filed: May 5, 2010
(86) PCT No.: PCT/IB10/51977

§ 371 Date: Nov. 17, 2011

Related U.S. Application Data
(60) Provisional application No. 61/179,734, filed on May 20, 2009.

(51) Int. Cl. G01N 23/04

(52) U.S. Cl. 378/20

(57) ABSTRACT

A system and method for monitoring a guided intervention device includes determining (306) a position of an intervention device inside a subject using a radiation source to image the intervention device. A circular acquisition is performed (304) to update the position of the intervention device wherein the acquisition includes skipping view angles by turning off a radiation source at given angular positions. A model of the intervention device is generated (308) to provide a virtual image of the intervention device against a background of the subject. Movement of the intervention device is modeled (310) during the skipped view angles to provide substantially real-time tracking of the intervention device.

This disclosure relates to medical imaging, and more particularly to a system and method for reducing radiation dosage to improve data acquisition and visualization of features in scan images.

Computed tomography (CT) guided interventions may be employed to perform procedures such as biopsies, catheterizations or other interventions using different mechanical or electromechanical devices. CT-guided interventions offer an opportunity to continuously update volumetric information being used as an anatomical roadmap in almost real-time. However, radiation doses associated with this type of scan mode are often high and may not be recommended. Such procedures may provide a radiation dosage far too high to be considered for a larger application spectrum in interventional radiology, cardiology, or oncology. Therefore, it would be advantageous to provide imaging techniques for intervention guidance with the advantages of CT scans but with low radiation dosage.

In accordance with the present principles, a system and method for monitoring a guided intervention device includes determining a position of an intervention device inside a subject using a radiation source to image the intervention device. A circular acquisition is performed to update the position of the intervention device wherein the acquisition includes skipping view angles by turning off a radiation source at given angular positions. A model of the intervention device is generated to provide a virtual image of the intervention device against a background of the subject. The device can be modeled whenever a new angle/projection is measured. Then, a 3D model results which can be overlaid on the volume.

Another method for monitoring a guided intervention device using CT—includes constructing an image volume of a patient by CT scanning, performing a circular acquisition to update a position of the intervention device wherein the acquisition includes skipping view angles by completely turning off an x-ray tube of the radiation source at given angular positions, and generating a model of the intervention device to provide a virtual image of the intervention device against a background of the image volume. The intervention device is modeled during at least one of the skipped view angles to provide tracking of the intervention device.

A system for monitoring an intervention device includes an image scanner configured to image an image volume of a subject and determine a position of an intervention device inside the subject using a radiation source. The image scanner is configured to perform a circular acquisition to update the position of the intervention device wherein the acquisition obtains images at periodic view angles by turning off the radiation source at given angular positions. A memory storage device is configured to store a model of the intervention device to provide a virtual image of the intervention device against a background of the image volume of the subject. The model is configured to provide movement of the intervention device during the periodic view angles to provide tracking of the intervention device. A display is configured to receive a modeled movement of the intervention device and to display the modeled intervention device against a last projection image of the image volume.

These and other objects, features and advantages of the present disclosure will become apparent from the following detailed description of illustrative embodiments thereof, which is to be read in connection with the accompanying drawings.

This disclosure will present in detail the following description of preferred embodiments with reference to the following figures wherein:

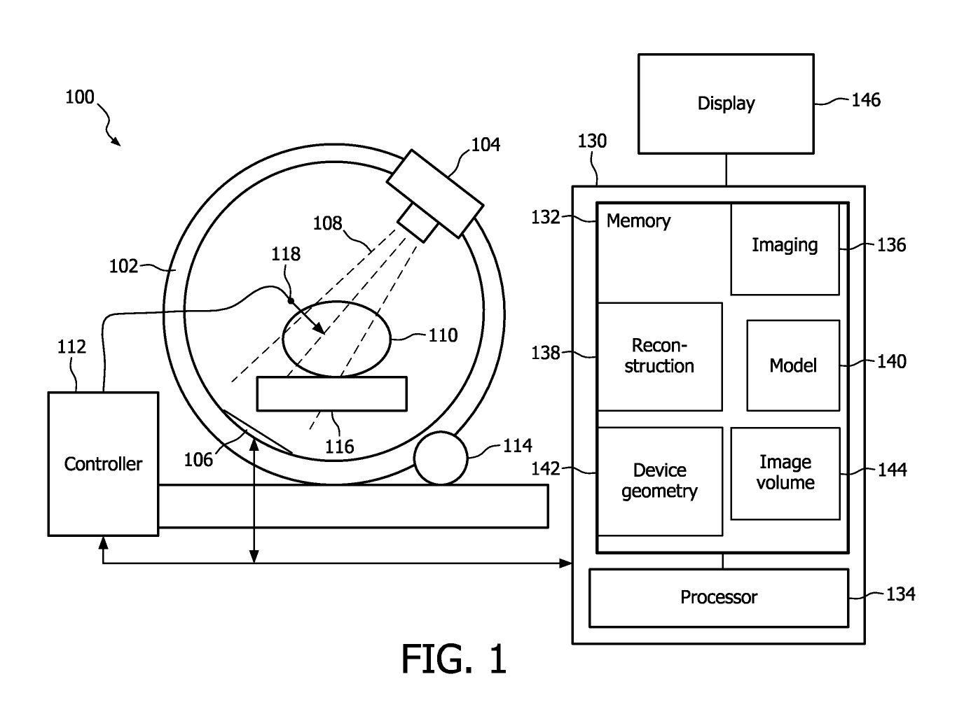

FIG. 1 is a diagram showing a system for data acquisition and visualization for guided intervention with low radiation dosage in accordance with the present principles; and

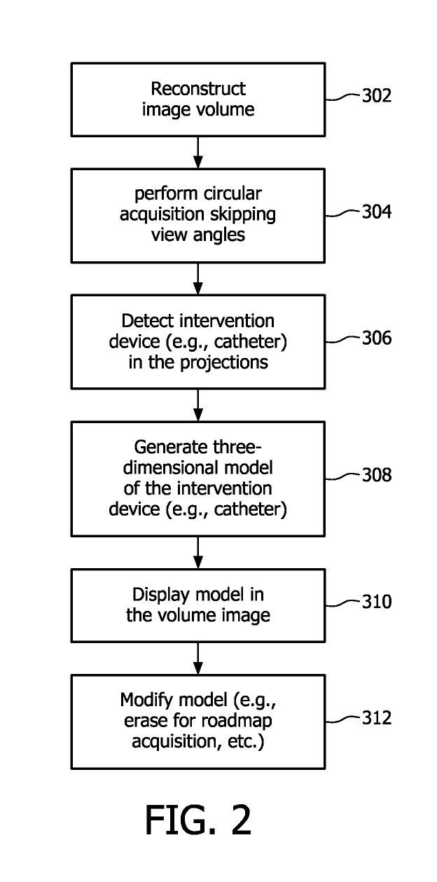

FIG. 2 is a block/flow diagram showing a system/method for data acquisition and visualization for guided intervention using a catheter for an ablation procedure in accordance with an illustrative embodiment of the present invention.

The present disclosure describes real-time updates of device information on most recent anatomical roadmaps using CT guidance for atrial fibrillation (AFIB) procedures or other procedures. The AFIB procedure will be described as a non-limiting illustrative example. However, the present systems and methods may be employed in any guided intervention procedure or any procedure where lower radiation dosage is desirable. It should be understood that the present principles will be described in terms of CT scans; however, the teachings of the present invention are much broader and are applicable to any scan technology. Further, a planetary set up for scanning images is described and shown; however, the present embodiments may be implemented on a C-arm device or any other type of continuous moving source-detector trajectory device (e.g., saddle trajectory, multiple circular arcs, etc.). The elements depicted in the FIGS. may be implemented in various combinations of hardware or hardware with software elements and provide functions which may be combined in a single element or multiple elements.

Referring now to the drawings in which like numerals represent the same or similar elements and initially to FIG. 1, a scanning system 100 with intervention guidance is illustratively shown in accordance with the present principles. The scanning system 100 includes a CT scan setup; however, other imaging technologies may also be employed. System 100 includes a gantry 102 which supports an x-ray source (e.g., an x-ray tube) 104 and an x-ray detector 106. The x-ray source provides a cone 108 of radiation for exposing a subject or patient 110. A guided intervention device 118 may include a needle, probe, trocar, catheter or any other medical device or implement, such as, e.g., an intervention device moving inside the body, which may be passive or actively driven, which is or is not mechanically connected to the outside of the body. The device 118 may be guided in accordance with feedback from the CT scan images. Device 118 may be guided using a guidance controller 112. The guidance controller 112 may include manual controls or may be automatically controlled using a software program. The controller 112 may use feedback from a plurality of sources, e.g., settings provided by a computer system 130 or stored in the controller 112. The guidance may be performed automatically or manually.

The gantry 102 rotates using motor 114. An x-ray detector 106 also rotates and is disposed on an opposite side of gantry 102 from source 104. In this way, x-rays are transmitted through the subject 110 and detected by detector 106. The x-rays are employed to generate CT scan images which may be stored in memory 132, displayed on a display 146, stored on portable media, such as memory media devices or films, or any combination of image rendering and storing.

In a particularly useful embodiment, the images collected are stored in memory 132. Images or slices are obtained by rotating the gantry 102 to expose the subject 110 to different angles of radiation. The images at each table position may be combined to provide a three-dimensional anatomical map called a volume image 144. In a preferred embodiment, a cone beam CT is employed and a volume is directly reconstructed at a given table position. The cross-sectional images are collected in the volume image 144 to accurately depict the anatomy of the patient. A table 116 may be translated into the gantry 102. During imaging the table 116 remains stationary. To generate a volume image, a simple circular scan is employed to cover the intervention volume.

In accordance with the present principles, anatomical roadmaps are provided during a minimally invasive intervention for a real time update of surgical device information for device 118. A significant dose reduction is achieved in CT-guided interventions by reducing the number of view angles where images are collected. This further includes a complete turning off or readjusting (e.g., dose modulation may be employed and but advantageously the present principles permit a full switching off of the x-rays) of the x-ray tube of the source 104. In one illustrative embodiment, five or more projections are taken in 180° of scanning This provides sufficient results given the fact that there may be some inconsistencies in the geometric position of the intervention device 118 and the subject 110 (breathing, cardiac motion, etc.). Current timing for tube switching of the source 104 is in the order of about 1-2 msec (e.g., 300-500 microsec for shut down and 300 microsec for rise—this may be slower at lower currents) (lower or higher switching times may also be possible), depending on the kV and mA applied to the tube. Assuming a view integration time of 100 microsecs and measuring 10 views per sample plus a 5-10 msec switching time, a total illumination of roughly 25 to 50 msec per half turn is achieved instead of about 150 msec illumination needed for a full half scan on the CT scanner for all view angles. In addition, it should be noted that in the process of switching the tube off (e.g., 5-10 msec), the dose in this time interval is far lower than in a normal view illumination. A dose reduction of about a factor of 10 is thus achieved in accordance with this illustrative embodiment. This provides for longer times in carrying out surgical procedures and/or less exposure to a patient.

In accordance with the present principles, the intervention device 118 is modeled using the previously taken images. Modeling of the device 118 may be implemented using projection filtering and segmentation and epi-polar geometry. Projection filtering and segmentation is used to detect and extract a 2D device model from the projection images. Epi-polar geometry refers to the geometry of stereo vision. When two (or more) vantage points view a three-dimensional (3D) scene or object from two (or more) distinct positions, there are a number of geometric relations between the 3D points and their projections onto 2D images that lead to constraints between the image points. These relations are derived based on the assumption that the vantage points can be approximated by a single point vantage (e.g., a pinhole camera model). The epi-polar geometry is used to transfer the 2D projection based intervention device segmentation into 3D space. More than two projections can be involved. In a small motion state, inconsistencies between subsequent projections used for the 3D modeling process, identical points on the catheter visible in two projections may not match exactly in the 3D model. To overcome this, shortest distance criteria can be applied to generate the 3D model which is best in agreement with the most recent measurements. In addition, an available pre-interventional device model can be integrated in the 3D modeling process. This may include a geometric model, including material properties, such as, e.g., the X-ray absorption coefficients of the device as well as mechanical properties including possible deformations during the intervention.

In this way, the modeled device 118 can be employed in the images to update the image with progressive movement of the device without collecting radiation images. This significantly reduces the radiation dosage applied to the patient 108 and the surrounding areas, reduces the tube activation times for the x-rays source, and permits real-time or near real-time intervention device information.

A partial (e.g., half) scan or full scan is carried out with a CT scanner 100, which generates a cone beam 108. A corresponding image volume 144 is reconstructed from the detected x-rays using reconstruction software 138, which combines the images to create the three-dimensional image volume. When the surgical device 118 is located in the image (as a result of the half or full scan), a circular acquisition (rotating the source 104 on the gantry 102) is carried out with the CT system 100, but a projection is measured only every few view angles, e.g., every 100 view angles, this interval may be greater or less depending on the procedure and the comfort level of the technician that sufficient information will be obtained at these view angles. The view angles may also be specified as every few degrees, e.g., 20° or 50° intervals. Within these projections, the device 118 is detected with fully automatic imaging software 136 using a scale space line filter and thresholding methods. Other imaging techniques such as filtering, contrasting, etc. may also be employed to improve the device detection. Additional images of the intervention device 118 may need to be erased from the projections which are used for anatomic roadmap generation. Since having these device images would cause motion/metal/or other artifacts in the anatomic roadmap if the device 118 is already in the body during this part of the acquisition

Using the known system geometry 142 of the device 118 and the image volume 144 of the patient 110, the relatively short difference in acquisition time between projections can be leveraged to create a 3D model 140 of the device 118. The model 140 of the device 118 may be generated using epi-polar geometry of the acquisitions stored in memory 132. The model 140 is generated from the last few projections that have been acquired (e.g., at least the last two projections). The 3D device model 140 is displayed on a display 146 in almost real time with low latency on the most recent anatomical roadmap. Since the intervention device 118 follows a known advance rate (controlled by computer or even manually) and the anatomical geometry of the patient 110 is known, accurate models 140 of the device 118 can be generated.

In a particularly useful embodiment, the image of the intervention device 118 is virtually updated using the model 140 created to follow the motion of the device 118. The motion is provided or even superimposed over the latest image or images of the image volume 144 of the patient 110 and is displayed on display 146. The virtual updates are preferably provided to fill in skipped view angle projections which were eliminated during the circular acquisition. The update rate of the virtual device image does not necessarily have to be performed for each missed viewing angle as the accuracy of the procedure or other factors can dictate this rate.

Computer system 130 includes a processor or processors 134, which works in conjunction with memory 132 to perform a plurality of operations and tasks in accordance with the present principles. Computer system 130 may be employed to control the gantry 102, the source 104, the detector 106, the table 116, controller 112 and any other systems or devices.

Further, system 130 is configured to render and process image data. For example, if the intervention device 118 is already in a field of view during acquisition of the projections to generate the anatomic roadmap, the device 118 needs to be detected and erased from the projections prior to reconstruction of the image. This is especially the case when an anatomic roadmap is updated during the intervention. In addition, the movement of the intervention device 118 in unacquired views may be needed in some applications. Using the multiple view angles, a three-dimensional model can be generated and projected onto the volume image 144 in a similar fashion as described. Other image processing may also be performed by computer system 130. It should be understood that the computer system 130 may include one or more distributed computers, which may be collocated or connected over a network or the Internet.

Referring to FIG. 2, a method for guided intervention in an AFIB procedure will now be illustratively described. To generate a roadmap of a left atrium—in which an ablation procedure takes place—a partial (e.g., half) scan or full scan is carried out with a cone beam CT scanner and the corresponding image volume is constructed or reconstructed in block 302. In block 304, when a catheter or other intervention device is located inside the right atrium (or other body part), a circular acquisition is carried out with the CT system, but only every, e.g., 100 view angles (could also be every 20° or other angle) a projection is measured. In block 306, within these projections, the catheter is detected with fully automatic software using a scale space line filter and thresholding methods (which use, e.g., pixel intensity and/or contrast to find and locate features in the image).

In block 308, using the known system geometry of the catheter and the anatomy of the patient, the relatively short difference in acquisition time is exploited. A 3D model of the catheter is generated using the epi-polar geometry of the acquisitions. The model is generated from the (at least) last two projections which have been acquired. The catheter model may be more complex than that of a needle due to geometric possibilities. Here, the catheter is inside the atrium and therefore it has freedom to move, however, modeling can be supported by anatomical constraints or mechanical constraints known from the catheter. The model need not be updated at each view angle. For example, the model may be updated when one view every 20° is acquired and has a rotation time of 270 msec. This would provide 18 updates per turn and about 60 per second, which is more than a normal video rate. Therefore, fewer updates are desirable.

In block 310, the 3D catheter model is displayed substantially in real time (e.g., at rates faster than normal video if needed) with low latency (the latency is mainly attributable to processing time of the intervention device image) on the most recent anatomical roadmap. The methods described herein will enable significant dose reduction in interventional CT. The same scenario can also be transferred to other CT guided interventions (other than AFIB).

In block 312, the model may need to be adjusted or removed. For example, if the intervention device is already in a field of view during acquisition of the projections to generate the anatomic roadmap, the device needs to be detected and erased from the projections prior to reconstruction of the image. This is especially the case when an anatomic roadmap is updated during the intervention.

In interpreting the appended claims, it should be understood that:
a) the word “comprising” does not exclude the presence of other elements or acts than those listed in a given claim;
b) the word “a” or “an” preceding an element does not exclude the presence of a plurality of such elements;
c) any reference signs in the claims do not limit their scope;
d) several “means” may be represented by the same item or hardware or software implemented structure or function; and
e) no specific sequence of acts is intended to be required unless specifically indicated.

Having described preferred embodiments for systems and methods (which are intended to be illustrative and not limiting), it is noted that modifications and variations can be made by persons skilled in the art in light of the above teachings. It is therefore to be understood that changes may be made in the particular embodiments of the disclosure disclosed which are within the scope and spirit of the embodiments disclosed herein as outlined by the appended claims. Having thus described the details and particularity required by the patent laws, what is claimed and desired protected by Letters Patent is set forth in the appended claims.

1. A method for monitoring a guided intervention device, comprising:
performing (304) a circular image acquisition of a subject with an intervention device including skipping view angles by switching a radiation source completely off at given angular positions;
generating (308) a model of the intervention device to provide a virtual image of the intervention device against a background image of the subject; and
modeling (310) the intervention device during at least one skipped view angle to provide substantially real-time tracking of the intervention device.

2. The method as recited in claim 1, wherein the radiation source includes x-rays generated using an x-ray tube.

3. The method as recited in claim 1, wherein performing (304) a circular acquisition includes scanning the subject using a computed tomography scanner.

4. The method as recited in claim 1, wherein skipping view angles includes obtaining a projection periodically.

5. The method as recited in claim 1, wherein generating (308) a model includes employing geometry of the intervention device and at least two last projection images to model the intervention device.

6. The method as recited in claim 1, wherein generating (308) a model includes modeling movement of the intervention device.

7. The method as recited in claim 1, further comprising transferring 2D projection intervention device segmentations into 3D space to create the model.

8. The method as recited in claim 7, further comprising applying a shortest distance criteria to generate the model in 3D space which is in best agreement with a most recent measurements.

9. The method as recited in claim 1, wherein generating (308) a model includes employing epi-polar geometry.

10. A method for monitoring a guided intervention device using computed tomography (CT), comprising:
constructing (302) an image volume of a patient by CT scanning;
performing (304) a circular acquisition to update a position of the intervention device wherein the acquisition includes skipping view angles by completely turning off an x-ray tube of the radiation source at given angular positions;
generating (308) a model of the intervention device to provide a virtual image of the intervention device against a background of the image volume; and
modeling (310) the intervention device during at least one of the skipped view angles to provide tracking of the intervention device.

11. The method as recited in claim 10, wherein skipping view angles includes obtaining a projection periodically.

12. The method as recited in claim 10, wherein generating (308) a model includes employing geometry of the intervention device and at least two last projection images to model the intervention device.

13. The method as recited in claim 10, wherein generating (308) a model includes modeling movement of the intervention device.

14. The method as recited in claim 10, wherein generating (308) a model includes employing epi-polar geometry.

15. The method as recited in claim 10, wherein tracking is provided in substantially real-time.

16. The method as recited in claim 10, further comprising determining (306) a position of an intervention device inside the patient using a radiation source to image the intervention device.

17. A system for monitoring an intervention device, comprising:
an image scanner (106) configured to image an image volume (144) of a subject and determine a position of an intervention device (118) inside the subject using a radiation source (104), the image scanner being configured to perform a circular acquisition to update the position of the intervention device wherein the acquisition obtains images at periodic view angles by turning off the radiation source at given angular positions;
a memory storage device (132) configured to store a model (140) of the intervention device to provide a virtual image of the intervention device against a background of the image volume of the subject, the model being configured to provide movement of the intervention device during the periodic view angles to provide tracking of the intervention device; and
a display (146) configured to receive a modeled movement of the intervention device and to display the modeled intervention device against a last projection image of the image volume.

18. The system as recited in claim 17, wherein the radiation source (104) includes an x-ray tube, and the image scanner includes a computed tomography scanner.

19. The system as recited in claim 17, wherein the model (140) includes geometry of the intervention device and at least two last projection images to model the intervention device.

20. The system as recited in claim 17, wherein an image of the intervention device (118) is superimposed on a background image of the image volume (144).

21. The system as recited in claim 17, wherein the model (140) is generated using epi-polar geometry.
